(19) United States
(12) Patent Application Publication
(10) Pub. No.: US 2025/0389408 A1
(43) Pub. Date: Dec. 25, 2025

(54) TELESCOPING LIGHTING SYSTEM

(71) Applicant: Delta Intelligent Building Technologies (USA), LLC, Oakland, NJ (US)

(72) Inventors: Avinash SANICHAR, Bloomfield, NJ (US); Ernesto BUCHANA, Clifton, NJ (US); Alister MALLET, Bushkill, PA (US)

(73) Assignee: Delta Intelligent Building Technologies (USA), LLC, Oakland, NJ (US)

(21) Appl. No.: 18/753,411

(22) Filed: Jun. 25, 2024

(51) Int. Cl. F21V 17/02; F21V 1/14; F21V 7/00; F21V 7/10; F21V 21/34; F21Y 103/10; F21Y 115/10

(52) U.S. Cl. CPC F21V 17/02; F21V 1/14; F21V 7/005; F21V 7/10; F21V 21/34; F21Y 2103/10; F21Y 2115/10

(57) ABSTRACT

A lighting system including a first and second housing portion, each defining two sidewalls and an intersecting crossbar connecting the two sidewalls. The lighting system has housing trims affixed to an exterior of the sidewalls of the first and second housing portions. Further, there is a first direct extrusion reflector positioned within and connected to the interior of the sidewalls of the first housing portion, and a second direct extrusion reflector positioned within and connected to the interior of the sidewalls of the second housing portion. A telescoping reflector is connected to the first direct extrusion reflector and laterally offset therefrom. A light shield is connected to the first housing portion and configured to guide along the housing trim of the second housing portion, enabling the lighting system to extend and retract in length.

### FIELD OF THE DISCLOSURE

The subject disclosure relates to lighting systems, and more particularly, to length adjustable linear lighting systems.

### BACKGROUND

Lighting systems have long been utilized to offer efficient illumination across diverse settings and applications. Among these systems, linear lighting solutions have gained significant popularity due to their versatility and ease of installation. Such systems typically involve the arrangement of prefabricated LED boards within a housing, emitting light through an output lens in a linear fashion.

However, a notable drawback of conventional linear lighting systems lies in their lack of adjustability in length. These systems typically rely on fixed configurations of LED boards, limiting the flexibility to customize lighting solutions according to specific needs and dimensions. In such setups, achieving varying light source lengths often necessitates either combining different numbers of prefabricated boards or utilizing boards of different lengths, which may not always align with the precise requirements of custom applications. Indeed designing lighting solutions for bespoke applications becomes challenging when restricted to the available sizes and types of prefabricated boards accessible in the market.

To address these drawbacks and enhance the versatility of linear lighting solutions, there is a need for innovations that enable adjustable length functionality without compromising efficiency or performance.

### SUMMARY

In accordance with the subject technology, embodiments of the disclosure include a lighting system. The lighting system has a first and second housing portion, each defining two sidewalls and an intersecting crossbar connecting the two sidewalls. Further, the lighting system has housing trims affixed to an exterior of the sidewalls of the first and second housing portions. A first direct extrusion reflector is positioned within and connected to the interior of the sidewalls of the first housing portion. A second direct extrusion reflector is positioned within and connected to the interior of the sidewalls of the second housing portion. Further, a telescoping reflector is connected to the first direct extrusion reflector and laterally offset therefrom. A light shield is connected to the first housing portion and configured to guide along the housing trim of the second housing portion, enabling the lighting system to extend and retract in length.

In other embodiments, the telescoping reflector and first and second direct extrusion reflectors may each have a first and second branch diverging and extending outwardly, the branches of the telescoping reflector and first and second direct extrusion reflectors each connected by a respective bridge. The branches of the first and second direct extrusion reflectors may be configured for snap connection to the first and second housing portions respectively.

Further, a mounting bracket may connect the bridge of the first direct extrusion reflector and the bridge of the telescoping reflector. The mounting bracket may define two plates offset vertically from each other such that, upon assembly, the telescoping reflector is positioned offset vertically from the first direct extrusion reflector. In this regard, in a retracted state, the first and second direct extrusion reflectors may abut each other, the first and second housing portions may abut each other, and the telescoping reflector may be configured to shelter partially underneath the second direct extrusion reflector. In an extended state, the first and second direct extrusion reflectors may be separated from each other by an adjustment gap, the first and second housing portions may be separated from each other by the adjustment gap, and the telescoping reflector may be configured to position within the adjustment gap.

In other embodiments, the lighting system may have a housing cover connected to the first housing portion and configured to slide along the intersecting cross bar of the second housing portion. The exterior of each sidewall may define an inward alcove and trim inlet each serving as a receiving terminal for joining with the housing trim, each housing trim defining a linking claw for insertion into the inward alcove and an intermediate rib for insertion into the trim inlet.

Each housing trim may extend between a linking claw and a foot, each housing trim having an intermediate junction defining an upward and downward standing ledge laterally off set from one another, and an elbow with a lateral projection and vertical projection. The light shield may define a ridge which rests on the intermediate junction of the housing trim, and a trench which wraps around and receives the lateral projection of the elbow.

In accordance with the subject technology, embodiments of the disclosure include a lighting system. The lighting system has a first and second housing portion, each defining two sidewalls with an interior and exterior. A first direct extrusion reflector is positioned within and connected to the interior of the sidewalls of the first housing portion. A second direct extrusion reflector is positioned within and connected to the interior of the sidewalls of the second housing portion. A telescoping reflector is connected to the first direct extrusion reflector via a mounting bracket and off set vertically and laterally from the first direct extrusion reflector. A guide rail system interconnects the first and second housing portion, enabling the lighting system to extend and retract in length. In an extended state, the first and second housing portions are separated from each other by an adjustment gap, and the telescoping reflector is configured to position within the adjustment gap.

In other embodiments, the lighting system may include housing trims affixed to the exterior of the sidewalls of the first and second housing portions. The exterior of the sidewalls may each define an inward alcove and trim inlet each serving as a receiving terminal for joining with the housing trims. Each housing trim may define a linking claw for insertion into the inward alcove and an intermediate rib for insertion into the trim inlet.

In accordance with the subject technology, embodiments of the disclosure include a lighting system. The lighting system has a first and second housing portion, each defining two sidewalls and an intersecting crossbar connecting the two sidewalls. A first direct extrusion reflector is positioned within and connected to the interior of the sidewalls of the first housing portion. A second direct extrusion reflector is positioned within and connected to the interior of the sidewalls of the second housing portion. A telescoping reflector is connected to the first direct extrusion reflector via a mounting bracket and off set vertically and laterally from the first direct extrusion reflector. The lighting system has a guide rail system including housing trims affixed to the exterior of the sidewalls of the first and second housing portions. The guide rail system has a light shield connected to the first housing portion and configured to guide along the housing trim of the second housing portion, enabling the lighting system to extend and retract in length, the telescoping reflector configured to position within an adjustment gap formed between the first and second housing portions upon extension.

### BRIEF DESCRIPTION OF THE DRAWINGS

Various aspects of the present disclosure are discussed herein with reference to the accompanying Figures. It will be appreciated that for simplicity and clarity of illustration, elements shown in the drawings have not necessarily been drawn accurately or to scale. For example, the dimensions of some of the elements can be exaggerated relative to other elements for clarity or several physical components can be included in one functional block or element. Further, where considered appropriate, reference numerals can be repeated among the drawings to indicate corresponding or analogous elements. For purposes of clarity, however, not every component can be labeled in every drawing. The Figures are provided for the purposes of illustration and explanation and are not intended as a definition of the limits of the disclosure.

FIG. 1A shows a top perspective view of a lighting system in a retracted configuration in accordance with the subject technology.

FIG. 1B shows a top perspective view of the lighting system of FIG. 1A in an extended configuration in accordance with the subject technology.

FIG. 2 shows an exploded perspective view of the lighting system of FIGS. 1A-1B in accordance with the subject technology.

FIG. 3 shows a cross-sectional plan view of the lighting system of FIGS. 1A-2 in accordance with the subject technology.

FIG. 4 show isolated, cross-sectional plan views of a housing and the installation of housing trims thereto, associated with the lighting system of FIGS. 1A-3 in accordance with the subject technology.

FIG. 5A shows a subjacent perspective view of the lighting system of FIG. 1A also in a retracted configuration in accordance with the subject technology.

FIG. 5B shows a subjacent perspective view of the lighting system of FIG. 1A also in an extended configuration in accordance with the subject technology.

FIG. 6A shows a side plan view of the lighting system of FIG. 1A also in a retracted configuration in accordance with the subject technology.

FIG. 6B shows a side plan view of the lighting system of FIG. 1B also in an extended configuration in accordance with the subject technology.

### DETAILED DESCRIPTION

The subject technology overcomes many of the prior art problems associated with lighting systems. The advantages, and other features of the technology disclosed herein, will become more readily apparent to those having ordinary skill in the art from the following detailed description of certain exemplary embodiments taken in combination with the drawings and wherein like reference numerals identify similar structural elements. It should be noted that directional indications such as vertical, horizontal, upward, downward, right, left and the like, are used with respect to the figures and not meant in a limiting manner.

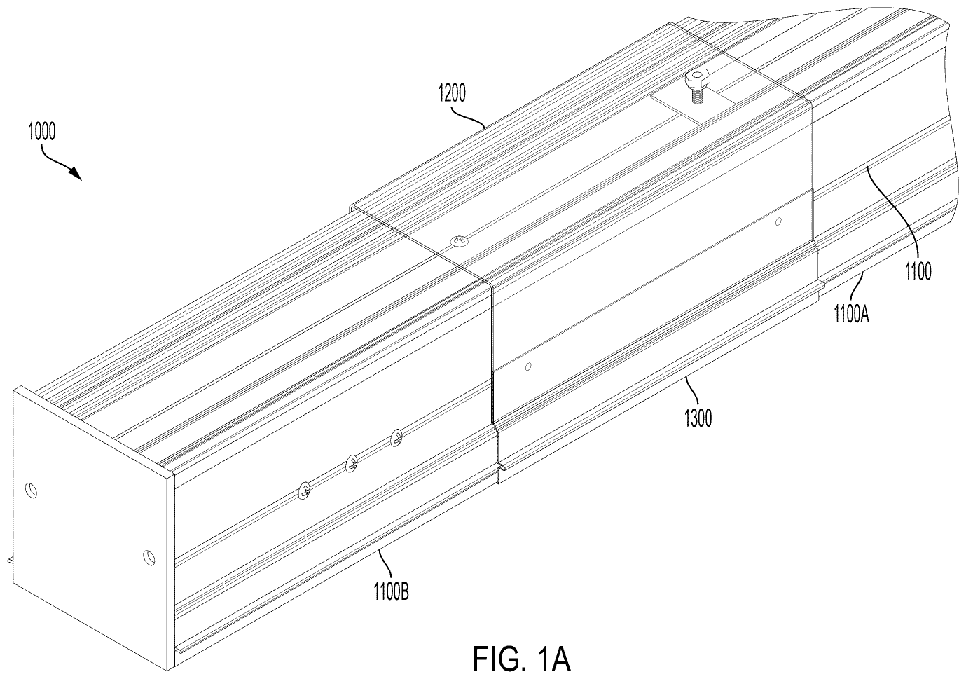

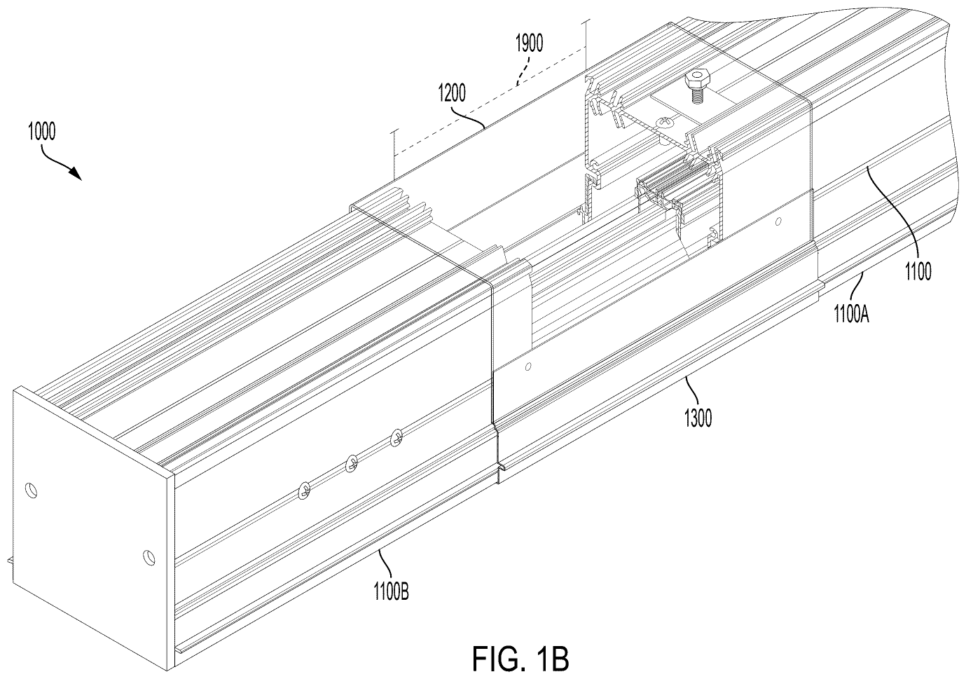

Referring now to FIGS. 1A and 1B, perspective views of a linear lighting system 1000 are shown. This luminaire 1000 uses elongated optics to distribute light over a more narrow area compared to traditional lighting. Usually, the linear lighting system 1000 is installed suspended from a ceiling, surface mounted to a wall or ceiling, or recessed into a wall or ceiling. Features, advantages, and principles taught by the description of linear lighting system 1000 can also be used in alternative types of lighting systems and systems such as, for example, recessed lighting, track lighting and monorail, chandeliers, pendants, sconces, ceiling lights, floor and table lambs, and outdoor lighting.

Notably, the linear lighting system 1000 is extendable, in that the system 1000 can extend and retract based on a desired length during installation. It is often expensive for a manufacturer to create, and a wholesaler to shelf, various sized lighting systems, and further, for a contractor to adjust the length of a desired lighting system during installation. Thus, the inventors of the subject application derived a unique solution thereto, described in full detail below.

The linear lighting system 1000 includes a housing 1100. The housing 1100 has a linear shape, extending, for example, along a depth dimension extending from the bottom left to upper right side of FIGS. 1A and 1B. Further, the housing 1100 is composed of shrouded aluminum, though, the size, material, and overall design of the housing 1100 can be varied based on concept or application.

The housing 1100 is split into two distinct portions, referred to herein as a first housing portion 1100A and a second housing portion 1100B. However, it's worth noting that the housing 1100 can come in several different configurations, including more than two housing portions. That is, concepts described herein range over several different housing arrangements and structures and should not be limited in nature to the embodiments discussed herein.

FIG. 1A shows the first and second housing portions 1100A, 1100B visibly integral, with a housing cover 1200 and light shield 1300 joining the two. However, in FIG. 1B, the first and second housing portions 1100A, 1100B are distanced from each other, separated by an adjustment gap 1900, though still connected by the housing cover 1200 and light shield 1300.

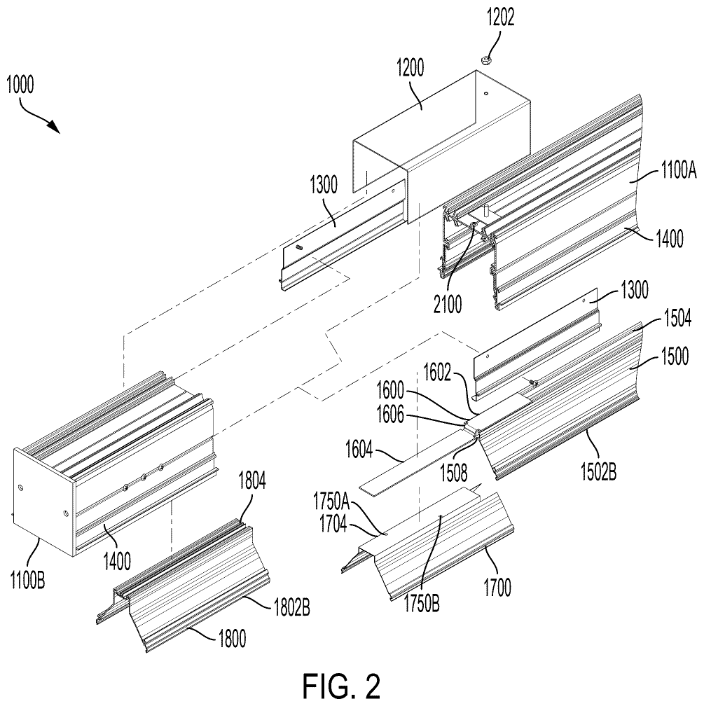

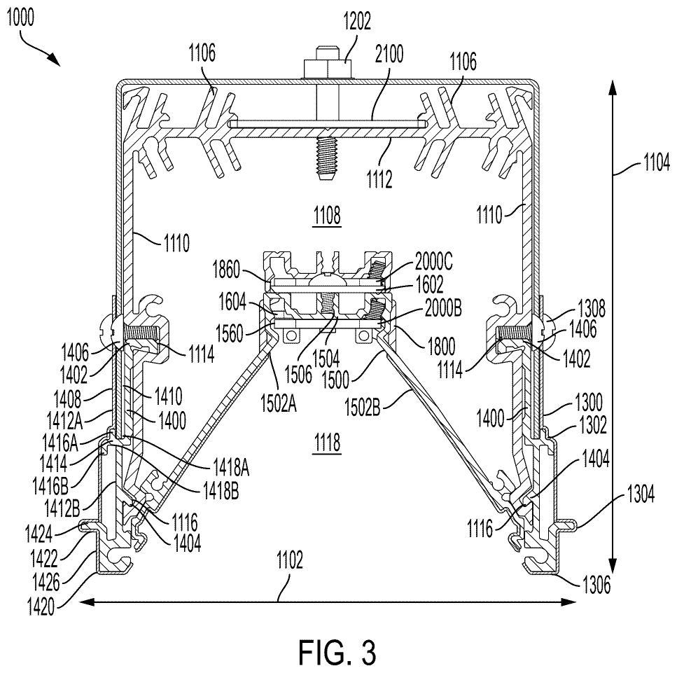

Referring now to FIGS. 2 and 3, exploded and cross-sectional views of the lighting system 1000 are shown. As mentioned with reference to the description prior, each housing portion 1100A, 1100B has a linear shape, extending, for example, along a depth dimension extending into or out of the page of FIG. 3. The housing portions 1100A, 1100B are rectangular shaped, prolonging in a horizontal dimension 1102 by roughly 2.0 inches, and a vertical dimension 1104 by roughly 3.5 inches. Further, the housing portions 1100A, 1100B are composed of shrouded aluminum, though, the size, material, and overall design of each portion 1100A, 1100B can be varied based on concept or application. Each portion 1100A, 1100B defines several screw bosses 1106 to aid in the assembly of mounting parts by providing channels for screws (not distinctly shown).

Collectively, the housing portions 1100A, 1100B define a housing cavity 1108 due to the flat-bottomed, U-shape configuration of the housing portions 1100A, 1100B, formed by sidewalls 1110 and an intersecting crossbar 1112 extending between the sidewalls 1110. The housing cavity 1108 provides a lighting environment for reflection and projection of light rays in a desired format and direction.

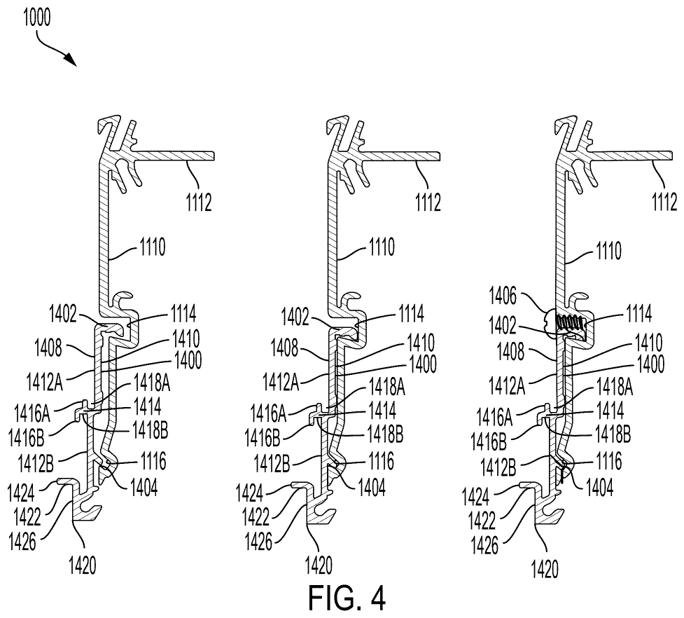

Referring additionally to FIG. 4, the sidewalls 1110 of the housing portions 1100A, 1100B, define an inward alcove 1114. The sidewalls 1110 of each housing portion 1100A, 1100B also each define a trim inlet 1116. The trim inlet 1116 and the inward alcove 1114 each serve as receiving terminals for joining with a housing trim 1400. As such, each of the inward alcove 1114 and trim inlet 1116 functions to interface with a housing trim 1400. For example, as best shown in FIGS. 3 and 4, the inward alcove 1114 depicted serves as a screw boss for attachment and lodging of a housing trim 1400 therein.

Various deployments of the housing trim 1400 can be realized for association with the housing portions 1100A, 1100B as best described in U.S. patent application Ser. No. 18/416,185, entitled REFLECTOR AND REFLECTOR HOUSING FOR A LINEAR LIGHTING SYSTEM and filed on Jan. 18, 2024, the entirety of which is incorporated herein by reference for any purpose whatsoever. In general, the housing trim 1400 is complimentary to the housing 1100, embodying a similar relative silhouette to the sidewalls 1110 and extending into the page of FIGS. 3 and 4. Each housing trim 1400 contemplated herein varies in size, shape, and functionality, and in turn, several further embodiments of the housing trim 1400 may be contemplated by the subject technology although not specifically enumerated herein.

Turning to the structure of the housing trim 1400, FIG. 4 exemplifies a housing trim 1400 with an linking claw 1402 for insertion into the inward alcove 1114, and an intermediate rib 1404 for insertion into the trim inlet 1116 of the housing 1100. A screw 1406 is driven into the inward alcove 1114 between the housing portion 1100A, 1100B and linking claw 1402, sandwiching the linking claw 1402 against the inward alcove 1114. By nature of the angled architecture of the intermediate rib 1404 defined by the housing trim 1400, it too is pressured into the trim inlet 1116, thus ensuring snug contact with the housing 1100.

The external surface 1408 of the housing trim 1400, opposite the internal surface 1410 abutting the housing 1100, defines a shape serving as a rail guide. In particular, and still referring to FIG. 4, the external surface 1408 of the housing trim 1400 begins at the linking claw 1402 and generally runs vertically, as defined in FIG. 3, between a first and second portion 1412A, 1412B, with an intermediate junction 1414 bisecting the sections. The intermediate junction 1414 defines an upward and downward standing ledge 1416A, 1416B, laterally off set from one another. Each ledge 1416A, 1416B, by nature of their projecting structure, forms a first and second linkage nexus 1418A, 1418B. Towards a foot 1420 of the housing trim 1400, opposite vertically of the linking claw 1402, the external surface 1408 of the housing trim 1400 defines an elbow 1422 with a lateral projection 1424 and a vertical projection 1426 that integrate with the foot 1420.

Referring back to FIG. 3, the light shield 1300 complements the external surface 1408 of the housing trim 1400 in shape for cooperation therewith. Specifically, the light shield 1300 defines a ridge 1302 which rests on the curved nature of the intermediate junction 1414 of the housing trim 1400. Further, the light shield 1300 defines a trench 1304 which wraps around and receives the lateral projection 1424 of the elbow 1422. Due to the shape of the trench 1304 and lateral projection 1424, the light shield 1300 is guided against the housing trim 1400 and rests comfortably thereon. The light shield 1300 defines a flume 1306 for receiving the foot 1420 of the housing trim 1400.

The light shield 1300 is screwed 1308 to the first housing portion 1100A as best shown in FIGS. 1A and 1B. Further, the housing cover 1200 is also screwed 1202 to the first housing portion 1100A and rests in the first linkage nexus 1418A of the housing trim 1400. Thus, the light shield 1300 and housing cover 1200 are statically positioned relative to the first housing portion 1100B, but can extend and retract relative to the second housing portion 1100B.

Indeed, the light shield 1300 can glide against the external surface 1408 of the housing trim 1400 of the first housing portion 1100A with minimal friction. There, the ridge 1302 of the light shield 1300 rests on the curved nature of the intermediate junction 1414 of the housing trim 1400 of the first housing portion 1100A and is capable of sliding thereon. The trench 1304 which wraps around and receives the lateral projection 1424 of the elbow 1422 of the first housing portion 1100A and is capable of sliding thereon. And further, the flume 1306 of the light shield 1300 receives the foot 1420 of the housing trim 1400 of the first housing portion 1100A and is capability of sliding against the foot 1420.

Though, the opposite may be true in other embodiments, where the light shield 1300 and housing cover 1200 are statically positioned relative to the second housing portion 1100B, but can extend and retract relative to the first housing portion 1100A. Either configuration enables the first and second housing portion 1100A, 1100B to retract and extend relative to one another.

With the progression between FIGS. 1A and 1B, elongated optics positioned within the housing portions 1100A, 1100B shift internally via extension and retraction with the housing portions 1100A, 1100B, to enable the same or similar distributed light pattern between the Figures. The referenced optics and maneuverability will be discussed below.

Referring again to FIGS. 2 and 3, situated in the housing cavity 1108 and connected to the first housing portion 1100A is a first direct extrusion reflector 1500 made of extruded acrylic, polycarbonate, and/or aluminum. The first direct extrusion reflector 1500 has a first and second branch 1502A, 1502B diverging and extending outwardly, each congruently sized and shaped and configured for connection to the first housing portion 1100A. The branches 1502A, 1502B meet at a bridge 1504, located at the top of the first direct extrusion reflector 1500, thus forming a flared branch U-shape. Detailed embodiments of the first direct extrusion reflector 1500 structure and connectivity to the housing are contemplated in U.S. patent application Ser. No. 18/416,185, entitled REFLECTOR AND REFLECTOR HOUSING FOR A LINEAR LIGHTING SYSTEM and filed on Jan. 18, 2024.

The bridge 1504 of the first direct extrusion reflector 1500 defines an additional screw boss 1506 for connection of constituent parts to the first direct extrusion reflector 1500. As shown in FIGS. 2 and 3, a mounting bracket 1600 is screwed to the first direct extrusion reflector 1500 via this screw boss 1506. The mounting bracket 1600 is defined by an upper and lower plate 1602, 1604 separated vertically by a hinge 1606, offsetting the two plates vertically and laterally. The upper plate 1602, when mounted, is generally aligned in orientation with the bridge 1504 of the first direct extrusion reflector 1500 into the page of FIG. 3, albeit not as long. When installed, the hinge 1606 abuts an extremity 1508 of the first direct extrusion reflector 1500, and the lower plate 1604 extends from the extremity 1508, thus enabling elongated lateral connection to a telescoping reflector 1700 as best shown in FIG. 2.

The telescoping reflector 1700 is formed of a similar material and has a similar shape and configuration as the first direct extrusion reflector 1500. For this reason, like reference numerals will be used to label the telescoping reflector 1700 as the first direct extrusion reflector 1500. The telescoping reflector 1700 deviates in configuration from the first direct extrusion reflector 1500 by the shape of the bridge 1704. The bridge 1704 of the telescoping reflector 1700 is rather planar as shown in FIG. 3, with a few screw holes 1750A, 1750B for attachment thereto, though lacking a screw boss.

While the upper plate 1602 of the mounting bracket 1600 is affixed to the bridge 1504 of the first direct extrusion reflector 1500, the lower plate 1604 affixes to the bridge 1704 of the telescoping reflector 1700. Due to the mounting bracket 1600 having an upper and lower plate 1602, 1604 separated vertically, the telescoping reflector 1700 is positioned vertically and laterally offset from first direct extrusion reflector 1500 upon assembly, such as along a vertical dimension 1104 shown in FIG. 3, and into the page of FIG. 3 respectively.

The mounting bracket 1600, and thus the telescoping reflector 1700, are static in movement relative to the first direct extrusion reflector 1500 in the embodiments shown, but it is envisioned that the pieces can be maneuverable along a rail (not distinctly shown). In such an embodiment, the telescoping reflector would be able to retract or extend relative to the first direct extrusion reflector. In the retracted position, the telescoping reflector and first direct extrusion reflector would vertically overlap, while in the extended position, the telescoping reflector and first direct extrusion reflector would laterally extend relative to one another.

Still referring to FIGS. 2 and 3, further situated in the housing cavity 1108 is a second direct extrusion reflector 1800, formed of a similar material and has a similar shape and configuration as the first 1500. For this reason, like reference numerals will be used to label the second direct extrusion reflector 1800 as the first direct extrusion reflector 1500. The second direct extrusion reflector 1800 is specifically connected to the second housing portion 1100B, and thus is adjusted in size to fit within the second housing portion 1100B. As with the first direct extrusion reflector 1500, detailed embodiments of the second direct extrusion reflector 1800 structure and connectivity to the housing are contemplated in U.S. patent application Ser. No. 18/416,185, entitled REFLECTOR AND REFLECTOR HOUSING FOR A LINEAR LIGHTING SYSTEM and filed on Jan. 18, 2024.

As mentioned prior, the telescoping reflector 1700 is positioned vertically below the first direct extrusion reflector 1500 upon assembly, such as along a vertical dimension 1104 shown in FIG. 3. Further, upon assembly, the telescoping reflector 1700 is also positioned vertically below the second direct extrusion reflector 1800.

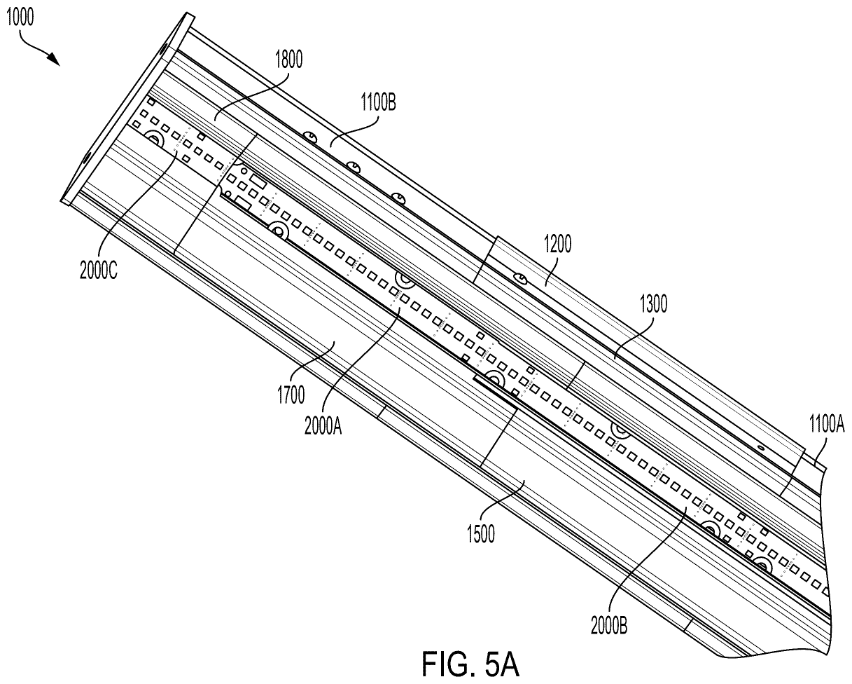

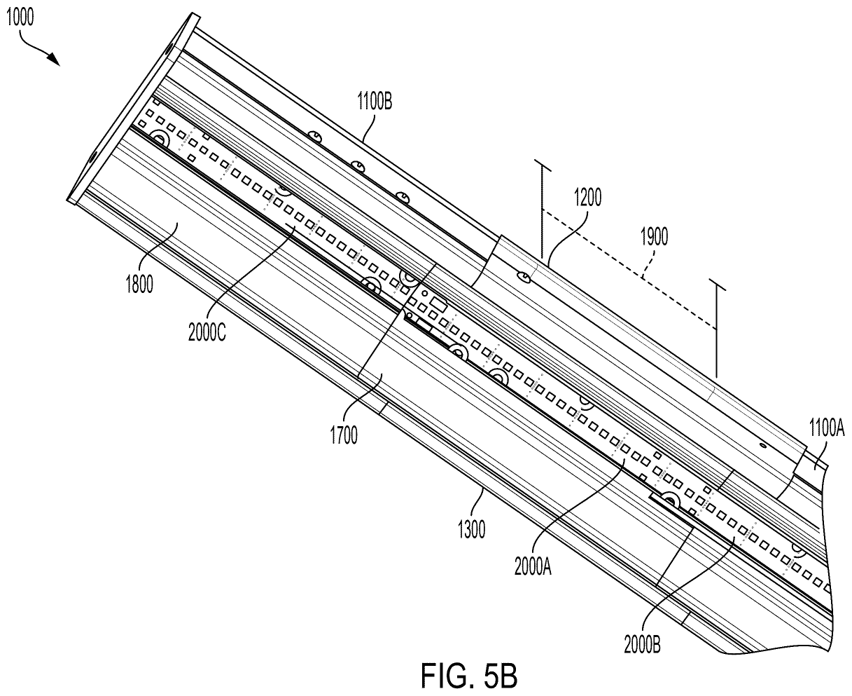

With this, FIG. 5A shows a retracted, subjacent view of the lighting system of FIG. 1A, while FIG. 5B shows an extended, subjacent view of the lighting system of FIG. 1B. In FIGS. 1A and 5A, the first and second housing portions 1100A, 1100B abut each other, forming a contiguous housing 1100. In a further respect, the first and second direct extrusion reflectors 1500, 1800, each separately positioned in their respective housing portion 1100A, 1100B, abut each other, forming a contiguous reflector. Because the mounting bracket 1600 affixed to the first direct extrusion reflector 1500 has an upper and lower plate 1602, 1604 separated vertically, the telescoping reflector 1700 is positioned vertically below the first direct extrusion reflector 1500 upon assembly, and thus slides beneath the second direct extrusion reflector 1800 as well.

When the first and second housing portions 1100A, 1100B are separated as shown in FIGS. 1B and 5B, the first and second direct extrusion reflectors 1500, 1800, are also separated from each other. Because the telescoping reflector 1700 is a laterally off set as an extension of the first direct extrusion reflector 1500, and upon retraction slides beneath the second direct extrusion reflector 1800, the telescoping reflector 1700 upon extension, fills the adjustment gap 1900 of the lighting system 1000.

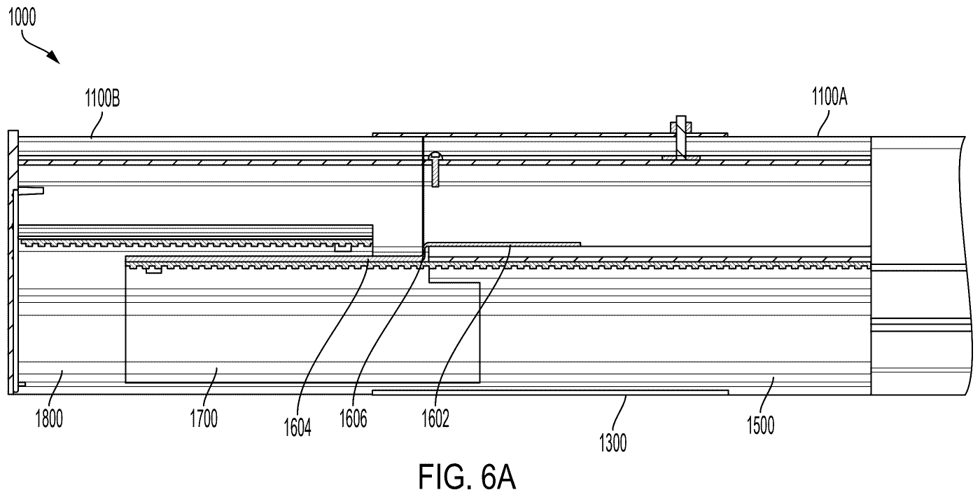

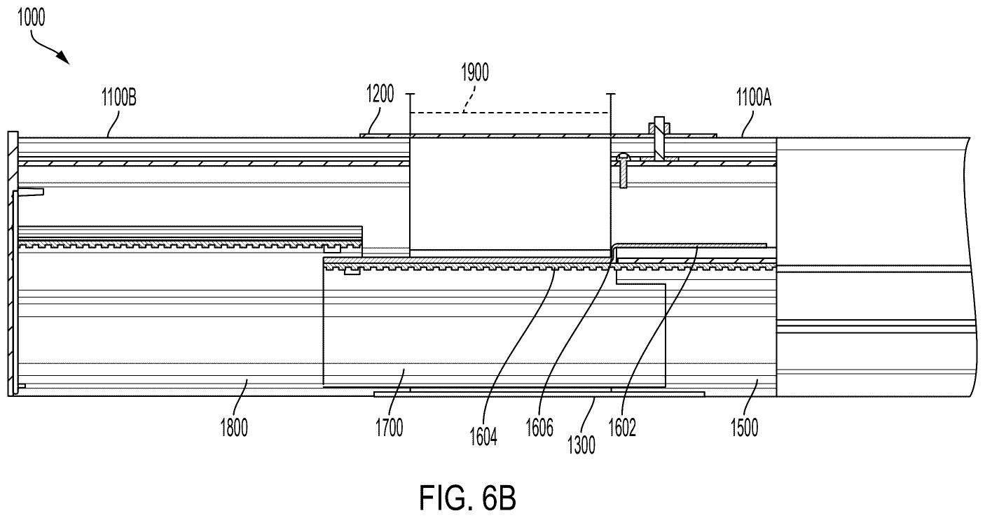

This is best shown in the progression between FIG. 6A and FIG. 6B. In FIG. 6A, the first and second housing portions 1100A, 1100B abut each other such as that shown in FIGS. 1A and 5A.

The telescoping reflector 1700 is positioned vertically below the second direct extrusion reflector 1800 in a retracted, overlapped configuration. Turning to FIG. 6B, the adjustment gap 1900 of the lighting system 1000 forms as the lighting system 1000 is lengthened and the first and second housing portions 1100A, 1100B are separated. The telescoping reflector 1700 extends from underneath the second direct extrusion reflector 1800 to fill the adjustment gap 1900, thus enabling the entire length of the lighting system 1000 to house a reflector in both retracted and extended configurations.

With that, the telescoping reflector 1700 and the first and second direct extrusion reflectors 1500, 1800 are each designated an LED printed circuit board 2000A, 2000B, 2000C which slide into elongated slots 1760, 1560, 1860 formed by the branches 1702, 1502, 1802 and bridge 1704, 1504, 1804, that is, into and out of the page of FIG. 2. The reflectors 1700, 1500, 1800, serve to guide light expelled from their respective LED printed circuit boards 2000A, 2000B, 2000C to a lighting target, forming an optical cavity 1118.

Each LED printed circuit board 2000A, 2000B, 2000C is used to mount diodes and power LEDs to project into the optical cavity 1108 of the linear lighting system 1000. Because these LEDs and their operation generate a large amount of heat, the LED printed circuit boards 2000A, 2000B, 2000C may include a heat sink (not distinctly shown) or structural material that draws away heat. Hence, the LED printed circuit boards 2000A, 2000B, 2000C may be made of aluminum material, which excels at transferring heat away from the board and assisting in thermal management, or fiberglass. Over a base aluminum or fiberglass layer is a dielectric layer, topped by a copper circuit layer and a solder mask.

Further situated in the housing portions 1100A, 1100B is one or more electrical control system (not distinctly shown) to power the LED printed circuit boards 2000A, 2000B, 2000C. The electrical control system is a linear regulator or driver which may exist in a packaged integrated circuit. The control system requires a rectified voltage source, e.g., a bridge rectifier to rectify an alternating current voltage to generate a low voltage, direct current serving as a driving voltage of the lighting system 1000. Thus, the electrical control system is a current regulator, converting line voltage into a requisite printed circuit board voltage utilized by the LED printed circuit boards 2000A, 2000B, 2000C situated in the housing cavity 1108. The electrical control system connects to the LED printed circuit boards 2000A, 2000B, 2000C via contact leads (not distinctly shown).

To assemble the linear lighting system 1000, and referring back to FIGS. 2 and 3, the upper plate 1602 of the mounting bracket 1600 is first affixed to the first direct extrusion reflector 1500 via the screw boss 1506 on the reflector bridge 1504. Thereafter, the lower plate 1604 of the mounting bracket 1600 is affixed to the telescoping reflector 1700 via the screw holes 1750A, 1750B on the reflector bridge 1704. In sequence, the first direct extrusion reflector 1500 is snapped into the first housing portion 1100A and the second direct extrusion reflector 1800 is snapped into the second housing portion 1100B such as the method described in U.S. patent application Ser. No. 18/416,185, entitled REFLECTOR AND REFLECTOR HOUSING FOR A LINEAR LIGHTING SYSTEM and filed on Jan. 18, 2024.

Next, the housing trims 1400 are screwed to each side of the first and second housing portions 1100A, 1100B sandwiching the linking claw 1402 of the trim 1400 against the inward alcove 1114 of the housing 1100, ensuring that the intermediate rib 1404 of the trim 1400 is also pressured into the trim inlet 1116. Further, the housing cover 1200 is aligned in length with the light shield 1300 and screwed to the first housing portion 1100A via the sidewalls 1110, resting in the first linkage nexus 1418A of the housing trims 1400. The housing cover 1200 is also bolted 1202 to the intersecting crossbar 1112 of the housing, through a cable gripper plate 2100.

The light shield 1300 is then fed into the aforementioned sliding configuration against the housing trim 1400 of the second housing portion 1100B, such that the ridge 1302 of the light shield 1300 rests on the curved nature of the intermediate junction 1414 of the housing trim 1400. The trench 1304 wraps around and receives the lateral projection 1424 of the elbow 1422 of the second housing portion 1100B, and further, the flume 1306 of the light shield 1300 receives the foot 1420 of the housing trim 1400 of the second housing portion 1100B. Due to this loose interconnection, the light shield 1300 can slide the relative to the second housing portion 1100B, the housing cover 1200 gliding over the crossbar 1112 of the second housing portion 1100B.

In operation, a user can adjust the length of the lighting system 1000 simply by applying a tensile force to separate or retract the first and second housing portions 1100A, 1100B. The reflector 1700 adjusts appropriately internally to fill the adjustment gap 1900. The aforementioned configuration advantageously does not require the reconstruction of the housing 1000. When powered, the LEDs emit light uniformly, and without break, along the length of the lighting system 1000, providing illumination and efficiently convert electrical energy into light, offering versatile, energy-efficient solutions for various applications such as architectural, accent, or task lighting.

It will be appreciated by those of ordinary skill in the pertinent art that the functions of several elements can, in alternative embodiments, be carried out by fewer elements, or a single element. Similarly, in some embodiments, any functional element can perform fewer, or different, operations than those described with respect to the illustrated embodiment. Also, functional elements shown as distinct for purposes of illustration can be incorporated within other functional elements in a particular embodiment.

While the subject technology has been described with respect to various embodiments, those skilled in the art will readily appreciate that various changes and/or modifications can be made to the subject technology without departing from the scope of the present disclosure.

1. A lighting system comprising:
a first and second housing portion, each defining two sidewalls and an intersecting crossbar connecting the two sidewalls;
housing trims affixed to an exterior of the sidewalls of the first and second housing portions;
a first direct extrusion reflector positioned within and connected to the interior of the sidewalls of the first housing portion;
a second direct extrusion reflector positioned within and connected to the interior of the sidewalls of the second housing portion;
a telescoping reflector statically connected to the first direct extrusion reflector, the telescoping reflector positioned vertically and laterally offset from the first direct extrusion reflector; and
a light shield statically connected to the first housing portion and configured to guide along the housing trim of the second housing portion,
wherein:
in a retracted state, the first and second housing portions abut each other, and the telescoping reflector is configured to shelter partially underneath the second direct extrusion reflector, and
in an extended state, the first and second housing portions are separated from each other by an adjustment gap, the first and second direct extrusion reflectors are separated from each other by the adjustment gap, and the telescoping reflector is configured to position within the adjustment gap.

2. The lighting system of claim 1, wherein:
the telescoping reflector and first and second direct extrusion reflectors each has a first and second branch diverging and extending outwardly, the branches of the telescoping reflector and first and second direct extrusion reflectors each connected by a respective bridge.

3. The lighting system of claim 2, wherein the branches of the first and second direct extrusion reflectors are configured for snap connection to the first and second housing portions respectively.

4. The lighting system of claim 2, further comprising a mounting bracket connecting the bridge of the first direct extrusion reflector and the bridge of the telescoping reflector.

5. The lighting system of claim 4, wherein the mounting bracket defines two plates offset vertically from each other such that, upon assembly, the telescoping reflector is positioned offset vertically from the first direct extrusion reflector.

6. (canceled)

7. The lighting system of claim 1, further comprising a housing cover connected to the first housing portion and configured to slide along the intersecting cross bar of the second housing portion.

8. The lighting system of claim 1, wherein the exterior of each sidewall defines an inward alcove and trim inlet each serving as a receiving terminal for joining with the housing trim, each housing trim defining a linking claw for insertion into the inward alcove and an intermediate rib for insertion into the trim inlet.

9. The lighting system of claim 1, wherein:
each housing trim extends between a linking claw and a foot, each housing trim having an intermediate junction defining an upward and downward standing ledge laterally off set from one another, and an elbow with a lateral projection and vertical projection, and
the light shield defines a ridge which rests on the intermediate junction of the housing trim, and a trench which wraps around and receives the lateral projection of the elbow.

10. A lighting system comprising:
a first and second housing portion, each defining two sidewalls with an interior and exterior;
a first direct extrusion reflector positioned within and connected to the interior of the sidewalls of the first housing portion;
a second direct extrusion reflector positioned within and connected to the interior of the sidewalls of the second housing portion;
a telescoping reflector statically connected to the first direct extrusion reflector via a mounting bracket and off set vertically and laterally from the first direct extrusion reflector; and
a guide rail system interconnecting the first and second housing portion, enabling the lighting system to extend and retract in length,
wherein:
in a retracted state, the first and second housing portions abut each other, and the telescoping reflector is configured to shelter partially underneath the second direct extrusion reflector, and
in an extended state, the first and second housing portions are separated from each other by an adjustment gap, the first and second direct extrusion reflectors are separated from each other by the adjustment gap, and the telescoping reflector is configured to position within the adjustment gap.

11. The lighting system of claim 10, wherein:
the telescoping reflector and first and second direct extrusion reflectors each has a first and second branch diverging and extending outwardly, the branches of the respective telescoping reflector and first and second direct extrusion reflectors connected by a respective bridge.

12. The lighting system of claim 11, wherein the branches of the first and second direct extrusion reflectors are configured for snap connection to the first and second housing portions respectively.

13. The lighting system of claim 11, further comprising a mounting bracket connecting the bridge of the first direct extrusion reflector and the bridge of the telescoping reflector.

14. The lighting system of claim 13, wherein the mounting bracket defines two plates offset vertically from each other such that, upon assembly, the telescoping reflector is positioned offset vertically and laterally from the first direct extrusion reflector.

15. (canceled)

16. The lighting system of claim 10, further comprising a housing cover connected to the first housing portion and configured to slide along the intersecting cross bar of the second housing portion.

17. The lighting system of claim 10, further comprising housing trims affixed to the exterior of the sidewalls of the first and second housing portions, wherein:
the exterior of each sidewall defines an inward alcove and trim inlet each serving as a receiving terminal for joining with the housing trims, and
each housing trim defines a linking claw for insertion into the inward alcove and an intermediate rib for insertion into the trim inlet.

18. The lighting system of claim 17, wherein:
each housing trim extends between the linking claw and a foot, each housing trim having an intermediate junction defining an upward and downward standing ledge laterally off set from one another, and an elbow with a lateral projection and vertical projection, and
the light shield defines a ridge which rests on the intermediate junction of the housing trim, the light shield further defines a trench which wraps around and receives the lateral projection of the elbow.

19. A lighting system comprising:
a first and second housing portion, each defining two sidewalls and an intersecting crossbar connecting the two sidewalls;
a first direct extrusion reflector positioned within and connected to the interior of the sidewalls of the first housing portion;
a second direct extrusion reflector positioned within and connected to the interior of the sidewalls of the second housing portion;
a telescoping reflector statically connected to the first direct extrusion reflector via a two-plate mounting bracket, one plate configured to connect to the telescoping reflector, and one plate configured to connect to the first direct extrusion reflector, the two-plate mounting bracket offsetting the telescoping reflector vertically and laterally from the first direct extrusion reflector; and
a guide rail system including:
housing trims affixed to the exterior of the sidewalls of the first and second housing portions; and
a light shield statically connected to the first housing portion and configured to guide along the housing trim of the second housing portion,
wherein:
in a retracted state, the first and second housing portions abut each other, and the telescoping reflector is configured to shelter partially underneath the second direct extrusion reflector, and
in an extended state, the first and second housing portions are separated from each other by an adjustment gap, the first and second direct extrusion reflectors are separated from each other by the adjustment gap, and the telescoping reflector is configured to position within the adjustment gap.
